(19) United States
(12) Patent Application Publication
(10) Pub. No.: US 2025/0104136 A1
(43) Pub. Date: Mar. 27, 2025

(54) A SYSTEM AND METHOD FOR PROVIDING VERSATILE SOLUTIONS TO RENTAL PLATFORM WITH ARTIFICIAL INTELLIGENCE

(71) Applicant: Mahendra RAWAL, Ontario (CA)

(72) Inventors: Mahendra RAWAL, Ontario (CA); Adrian GUPTA, Ontario (CA)

(21) Appl. No.: 18/730,562

(22) PCT Filed: Mar. 19, 2022
(86) PCT No.: PCT/IN2022/050269

§ 371 Date: Jul. 19, 2024

(30) Foreign Application Priority Data
Jan. 19, 2022 (IN) 202221003078

(51) Int. Cl. G06Q 30/0645; G06Q 10/1093; G06Q 50/16

(52) U.S. Cl. CPC G06Q 30/0645; G06Q 10/1095; G06Q 50/16

(57) ABSTRACT

A system (1) and method for providing versatile solutions to rental platform with artificial intelligence. The present invention generally provides a system for leasing the property for short term and long term including a cloud server (2). Database server (3), load balancers (4), User Interface (5), admin Interface (8), third party API apps (10) and plurality of functioning components including meeting management platform (1013), calendar management where landlord can easily manage meetings for property showing and manage the meeting dates. Landlord and tenant meet through video conferencing for showing the property at convenient time of both the parties. Further invention also comprises guarantor services for long term leasing, supplementary services like cleaning, plumbing, etc. and insurance services for users. Invention also comprises seasonal pricing management platform (52) and cancellation and refund services (20) for short term leasing. The present invention also discloses the process step for performing the functioning components.

### FIELD OF THE INVENTION

The present invention relates to a system and method for providing versatile solutions to rental platform with artificial intelligence and more particularly it relates with comprehensive computer system for automating and facilitating the house leasing or rental process.

### BACKGROUND OF THE INVENTION

At present renting houses has become a necessary living condition for contemporary young people however, the existing renting and leasing technology is absolutely dominant in a fragmented way. Real-estate transactions pertaining to lease/rental spaces typically involve many participants, including landlords, tenants, agents, brokers, real estate developers, loan officers, and money lenders. Each participant typically maintains various information about the real-estate properties for which they are involved in a transaction.

Earlier real estate marketing and management have been conducted using paper intensive systems and generally lag behind other industries in embracing digital technology. For example, it is commonplace to place an advertisement for a property in a local newspaper providing a brief description of the property. This advertisement may or may not include a photograph of the property. The landlord/property owner pays the newspaper a fee for such advertisement. Then, an individual seeking to become a resident of the community by leasing or purchasing a residential or commercial property, must scan the same newspaper while the advertisement is in daily news paper. Once this prospective resident has selected a property based on the sparse information provided in the advertisement, the prospective resident typically contacts the owner or owner's representative or landlord's agent by calling a phone number listed in the advertisement. For example, in a rental setting, the owner may take some preliminary information over the phone and may agree to show the property to the prospective renter. Once the property is shown, the owner provides the prospective renter with a rental agreement form. Often, the owner requires a credit check for which the prospective renter must pay a fee. If an agreement is entered into, the prospective renter will usually pay the first and last month's rent plus a security deposit.

The potential renter/tenant is similarly provided with insufficient information in the advertisement to make an informed decision, and will often waste significant time viewing several properties, many of which will not meet his or her criteria. The advertisements may also omit descriptions of the surrounding neighborhoods and local culture, leaving the prospective renter to discover this type of information from co-workers or neighbor, or through his or her own visit to the community. This is often a time consuming process. This problem is more acute for those renters relocating to an unfamiliar area. In addition, the newspaper advertisements are often outdated and the prospective renter wastes time calling on properties that are no longer available because the properties listings are only updated on a periodic basis.

Another aspect generally lacking in such a rental transaction is a property management feature. Often, the property owner seeks merely to list the property and turnover its management to a property manager to collect the monthly rental fees and otherwise manage the property. The property owner will often contract with an independent property manager to run the property, thus adding another level of complexity to the transaction.

While current attempts exist to provide access through a network, such as the Internet, to property listings available for rental or purchase, these services often require the prospective resident to pay a subscription fee. In addition, the listings often only duplicate the less information found in the newsprint advertisements, and frequently contain out of date listings. Thus, the prospective resident often pays for outdated information, and is provided with little additional information other than that which can be learned by scanning the advertisements. Moreover, as the property owner stands to make the largest gains, in some instances it would be more appropriate for the property owner to bear the burden of advertising and search costs. In this regard, the property owner will be influenced by a desire to maintain a full tenancy or to sell the property with expedience.

Further during the period when a real estate lease contract is concluded or a contract is concluded, a variety of situations may arise for contractual interest stakeholders, and it is a reality that stakeholders have to incur considerable time and expense to cope with such situations properly. This property rental process can be arduous and time consuming.

In current available technology after finding his/her potential property via any websites or any online platform, prospective tenants must often travel to realtor offices, management companies, or the rental property itself to view some of the features of the property and to submit their credit or rental history. Landlords are also plagued with the inconvenience of traveling to the property and managing long-distance paper Submissions, including credit histories, rental applications, leases, and rental payments. Further after viewing agreeing the terms and conditions landlords and tenants have to search for lawyer for notarizing the agreement. In addition, potentials tenants may be relocating from another state and landlords may not reside in the same city or state as the properties they manage. The geographical gap between potential tenants, landlords and the properties of interest subsequently hinders the efficiency of timely property rentals.

Further short-term housing rentals include vacation rentals, which are independently owned homes, condominiums, timeshares or other property, which are rented out to prospective guests. Often, property owners will contract with a property manager to market and rent out their vacation home. Traditionally, property owners and property managers will enter into a contract that sets marketing and pricing parameters. The property manager then markets that home, provides keys to the guests, Supervises ongoing maintenance and housekeeping, and remits a portion of the proceeds back to the property owner.

Thus, the conventional method of connecting property owner/tenants/lawyer/guests for property transaction and the entire process of renting the property is very lengthy and time consuming. At times, this whole process may extend over couple of days, weeks or months.

Existing systems provides services and information in bits and pieces. Hence, there is a need for an internet-based real estate transaction platform that overcomes the limitations of existing, connects the landlords/tenants/guests in a novel and efficient manner, where the potential users can select the best deal as per their requirements in short period of time.

### OBJECT OF INVENTION

The main object of the present invention is to provide a system and method for long term leasing for providing versatile solutions to rental platform with artificial intelligence.

Another object of the present invention is to provide a smoother, simpler, continuous system and method for providing versatile solutions to rental platform with artificial intelligence.

Yet another object of the present invention is to provide a system and method for property listing and property showing.

Yet another object of the present invention is to provide system and method for meeting management tool for effective mechanism to find interested tenant and landlord.

Yet another object of the present invention is to provide system for calendar management tool and video conference for ease and convenience of landlords and tenants.

Yet another object of the present invention is to provide system and method for agreement negotiation and notarization for tenant and landlord.

Yet another object of the present invention is to provide system and method for leasing/subleasing for tenants and landlords.

Yet another object of the present invention is to provide system and method for guarantor services and insurance services to the tenants and landlords.

Yet another object of the present invention is to provide system and method for supplementary services like cleaning, electricity services, plumbing services, Tiffin services, etc for tenants and landlords.

Yet another object of the present invention is to provide system and method for payment facilitation for tenants and landlords.

Yet another object of the present invention is to provide system and method for short term leasing for providing versatile solutions to rental platform with artificial intelligence.

Yet another object of the present invention is to provide system and method for seasonal pricing management for short term leasing.

Yet another object of the present invention is to provide cancellation and refund services to the user for short term leasing.

Still yet another object of the present invention is to provide system and method for fast, effective and economical solution in rental space.

Other objects and advantages of the present disclosure will be more apparent from the following description which is not intended to limit the scope of the present disclosure.

### SUMMARY OF THE INVENTION

A system and method for providing versatile solutions to rental platform with artificial intelligence. The present invention generally provides a system for leasing the property for long term and short term including a cloud server, Database server, load balancers, User Interface, admin Interface, third party API apps and plurality of functioning components including meeting management platform, calendar management where landlord can easily manage their meetings for property showing and manage the meeting dates. Landlord and tenant meet through video conferencing for showing the property at convenient time of both the parties. Further invention also comprises guarantor services for long term leasing, supplementary services like cleaning, plumbing, etc, and insurance services for tenant. Further invention also comprises seasonal pricing management platform and cancellation and refund services for short term leasing. The present invention also discloses the process step for performing the functioning components.

### BRIEF DESCRIPTION OF DRAWING

FIG. 1 illustrates a schematic representation of a system infrastructure for long term leasing and method for providing versatile solutions to rental platform with artificial intelligence.

FIG. 2A-2C illustrates a flowchart representation of a system infrastructure and method for providing versatile solutions to rental platform with artificial intelligence.

FIG. 3 illustrates a flowchart of process step for meeting management platform according to FIG. 2B of the present invention.

FIGS. 4A and 4B illustrates a flowchart of process step for meeting according to FIG. 2B of the present invention.

FIGS. 5A and 5B illustrates a flowchart of process step for lawyer meeting manager according to FIG. 2C of the present invention.

FIG. 6 illustrates a flowchart of process step for tenant's insurance according to FIG. 2C of the present invention.

FIG. 7 illustrates a flowchart of process step for notification system according to FIG. 2C of the present invention.

FIG. 8 illustrates a flowchart of process step for guarantor service of the present invention.

FIG. 9 illustrates a schematic representation of a system infrastructure for short term and method for providing versatile solutions to rental platform with artificial intelligence.

FIG. 10 shows a process step for seasonal pricing management of present invention.

FIG. 11 shows a process step for cancellation services of present invention.

FIG. 12 illustrates a flowchart of process step for supplementary services of the present invention.

### DETAILED DESCRIPTION OF THE INVENTION

Before explaining the present invention in detail, it is to be understood that the invention is not limited in its application to the details of the construction and arrangement of parts illustrated. The invention is capable of other embodiments, as described above and of being practiced or carried out in a variety of ways. It is to be understood that the phraseology and terminology employed herein is for the purpose of description and not to limitation. The invention may have various embodiments and they may be performed as described in the following pages of the complete specification.

As used herein, the term “property”, discloses, refers to any immovable property i.e. “real property”; it is land or any permanent feature or structure above or below the surface i.e. residential, commercial, government, private, disputed etc.

As used herein, the term “user”, discloses, refers to any user i.e. landlord, tenant, lawyer, travelers, professionals, students, guests, host, third party partners etc.

As used herein, the term “Computing device”, discloses, refers to any device i.e. mobile phone, tablet, laptop or computer etc.

As used herein, the term “network” refers through many interfaces including an internet or such as a local area network (LAN) or a wide area network (WAN), dial-in-connections, cable modems, special high-speed Integrated Services Digital Network (ISDN) lines, and RDT networks.

As used herein, a “processor” includes any programmable system including systems using micro-controllers, reduced instruction set circuits RISC), application specific integrated circuits (ASICs), logic circuits, and any other circuit or processor capable of executing the functions described herein. The above examples are example only, and are thus not intended to limit in any way the definition and/or meaning of the term “processor”. It is designed with AI (Artificial Intelligence) and machine learning tools. It includes front-end programming languages (i.e. React, Angular, HTML, CSS, JavaScript or Swift) or back-end programming languages (i.e. C #, Python, Node.js).

As used herein, the term “platform” is interchangeable and includes any module, tools, components or any device program stored in memory for execution by processor. It is not intended to limit in any way the definition and/or meaning of the term “platform”. As used herein, the term “database” refers to either a body of data, a relational database management system (RDBMS), or to both. The database includes any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database.

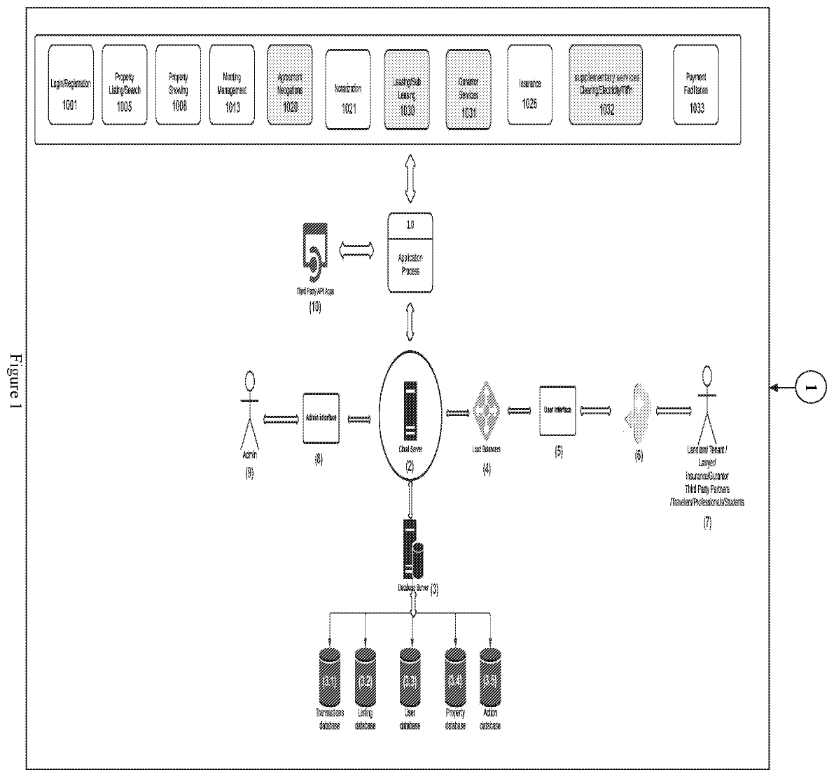

FIG. 1 illustrates a schematic representation of a system (1) for providing versatile solutions to rental platform with artificial intelligence. The present invention comprises a system (1) including an Computing device (not shown in figure), a network (6), an User Interface (5), a load balancers (4), a cloud server (2), a Database server (3), an admin Interface (8) and a third party application programming interface apps (10). In the present invention, system (1) includes the Computing device operates by user and user can access the system (1) through Computing device via network. Here Computing device refers to any device like computers or laptops, mobile device and the like. Further system (1) comprises the load balancers (4) which distributes the information received from the user throughout cloud server (2) and Database server (3). User Interface (5) preferably allows a user to establish a connection with the cloud server (2).

Servers execute processing, storage and capabilities of information transmitted over the internet. Each server comprises one or more processor coupled with memory and storage device and operating system (1) packages that allow the system (1) to function.

The primary Database server (3) includes a transaction database (3.1), a listing database (3.2), a user Database (3.3), a primary database and an action database (3.5). The databases are interconnected and can be integrated into a single database. The servers are in turn connected to the admin via admin Interface (8).

The Admin Interface (8) preferably allows admin to manage the system (1) residing on cloud server (2). Admin is preferably able to manage authentication information for users, and other entities that may connect to server. Additionally, admin Interface (8) may allow admin to configure the communication requirements for server to communicate with other entities such as screening companies, third party vendors, payment processors, ancillary service providers, and the like.

Continuing to FIG. 1, system (1) comprises plurality of functioning components illustrating a login/registration platform (1001) from which user can register and may use the system (1), a property listing/search platform (1005) where user can search for a property and list their property for rent, a property showing platform (1008) where user can view their listed property, a meeting management platform (1013) and through meeting management platform landlord is able to provide various integrated virtual property showing to the tenant via video conferencing, an agreement negotiation platform (1020) where user can finalize the tenancy agreement, a notarization platform (1024) where user get e-signature and lawyer notarization, a leasing/sub leasing platform (1030) for landlord and tenant, a guarantor services (1031) for tenant, an insurance services (1026) for tenants, an supplementary services like cleaning, electricity, Tiffin services and the like and payment facilitation and the said elements are designed with AI (Artificial Intelligence) and machine learning tools. Further system (1) includes third party application programming interface apps (10) which allows user to access their functionality via application process and use it on system (1).

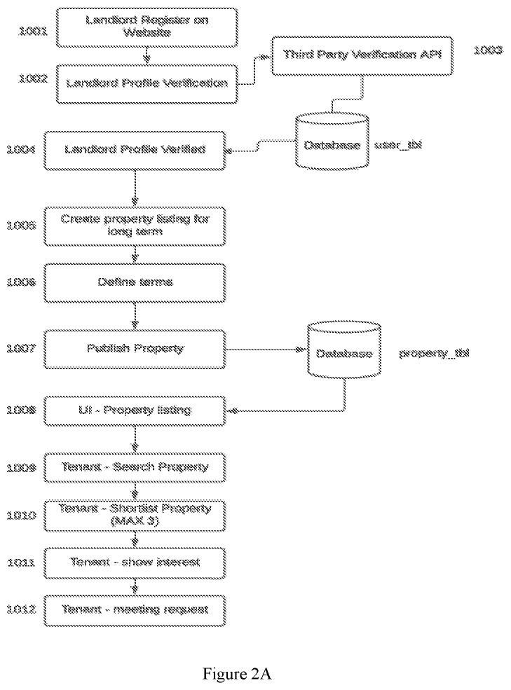

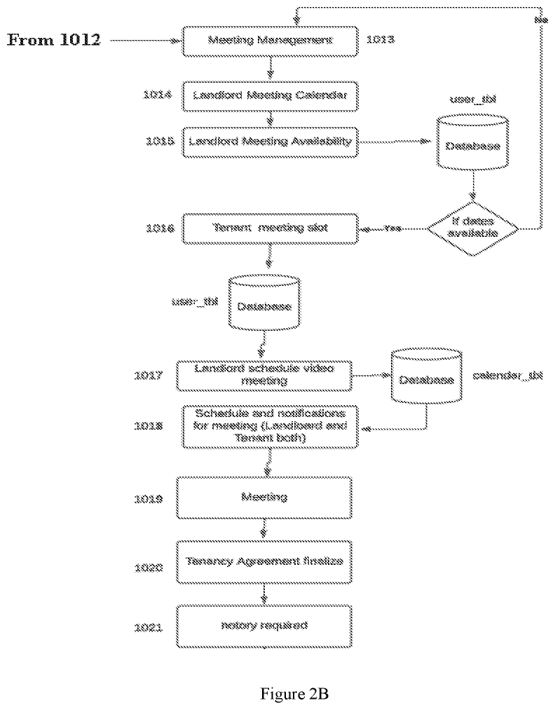

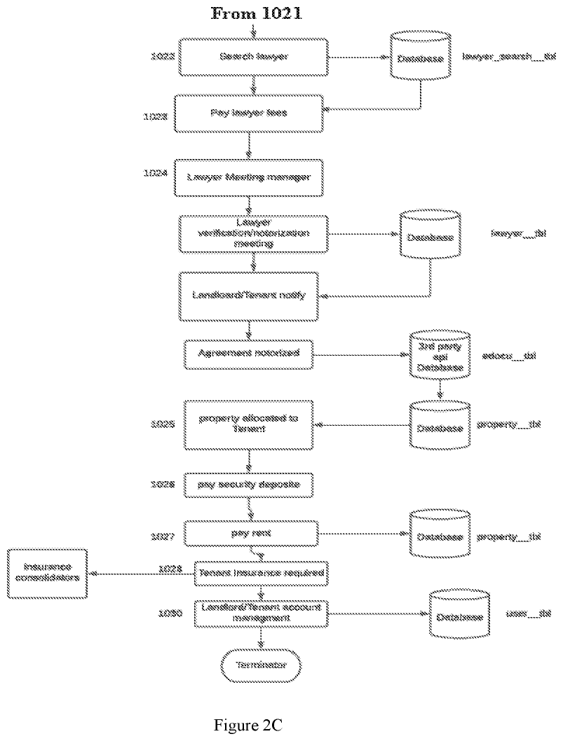

FIG. 2A-2C depicts the process steps of a system (1) for providing, managing and preparing documentation for property rental transaction for long term leasing according to the present invention. As illustrated in step (1001) of FIG. 2A, a landlord is required to register into the system (1) on login/registration platform. Once the landlord registered into the system (1), system (1) verifies the landlord profile as illustrated in step (1002), system (1) will verify the landlord profile via third party verification application programming interface as illustrated in step 1003. System (1) stores the registered data of the landlord in user Database (3.3). After verification of landlord's profile, landlord is able to create property listing for long term leasing on property listing/searching platform as indicated in step (1005). Once the landlord has created the property listing, landlord has to define the terms for property as indicated in step (1006) and after the said step system (1) will publish the landlord's property on property showing platform into the system (1) and store into the property Database (3.4) as shown in step (1007). When tenant searches for a property as shown in step (1009) on property showing platform, tenant will get a number of properties in UI-property listing (1005). From the said listing tenant can shortlists the maximum 3 numbers of properties as shown in step (1010).

Once the tenant shows the interest to the selected property, tenant can send the meeting request on the meeting management platform (1013). After getting meeting request from the tenant, system (1) view into landlord meeting calendar (1014) and checks for meeting availability (1015). System (1) will check for available dates into user Database (3.3). If dates are not available, system (1) again redirects the tenant to the meeting management platform (1013) and if dates are available tenant is able to book a meeting slot (1016). Once booking a meeting slot, system (1) will store the said data of meeting into the user Database (3.3). After step (1016), landlord will schedule a video meeting into the system (1) as illustrated in step (1017) and system (1) will store the scheduled meeting in database. Afterwards system (1) will send the notification for meeting to the landlord and tenant at scheduled time as illustrated in step (1018).

After completion of meeting as shown in step (1019), tenant and landlord finalize tenancy agreement (1020) on agreement negotiation platform and if they want to notarize the tenancy agreement, system (1) start searching for available lawyers (1022) on notarization platform. System (1) receives the lawyer information from database. After getting the lawyer landlord or tenant have to pay the fees for lawyer as shown in step (1023). Once the fees paid system (1) go for lawyer meeting manager (1024) where lawyer will verify the documents and notarize the agreement and if meeting is required for verifying the documents, lawyer is able to schedule a video meeting into the system (1). Said step (1024) will be explained later in detail. Landlord and tenant will get the notification once the documents being verified.

Once the agreement notarized system (1) stores the data into the property Database (3.4) and property will be allocated to the tenant as shown in step (1025). After the property allocation tenant have to pay security deposit and rent to the landlord as shown in step (1026) and (1027). Tenant may pay the security deposit and rent via payment gateway into the system (1). Tenant may also pay directly to the landlord via offline mode. System (1) also comprises tenant insurance (1028) and landlord/tenant account management (1030) which will be explained later in detail.

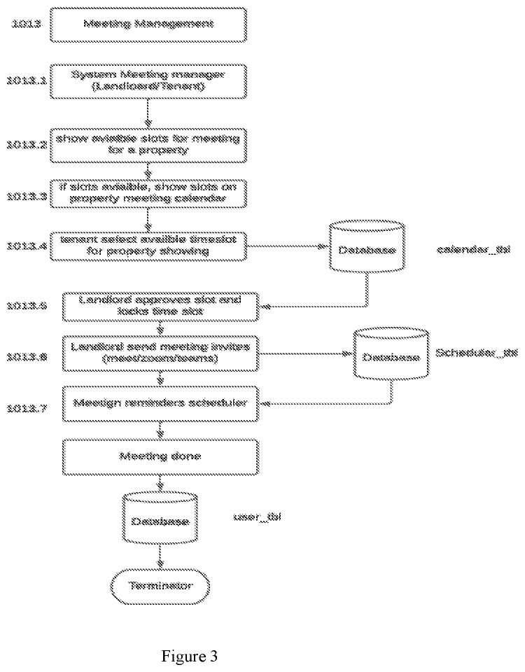

FIG. 3 illustrates a detailed process step for meeting management (1013). The process begins with step (1013), comprising system meeting manager (1013.1) for landlord and tenant. System (1) shows available slots for meeting for a property to the tenant as shown in step (1013.2). If slots are available for the meeting, it will be shown on property meeting calendar as illustrated in step (1013.3). Tenant selects the available timeslot for meeting as shown in step (1013.4) and system (1) stores the selected time slot in calendar database. After step (1013.4), landlord approves the slot and locks the time slot for meeting as illustrated in step (1013.5). After approving the slot landlord send the meeting invites to the tenant via meet, zoom, teams, etc. as stated in step (1013.6). System (1) stores the meeting data into database and sends the meeting reminders to the landlord and tenant as shown in step (1013.7).

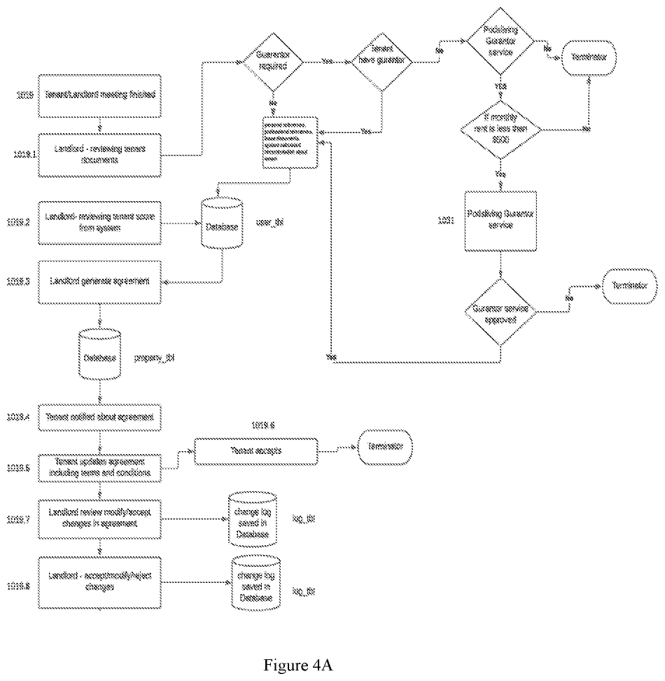

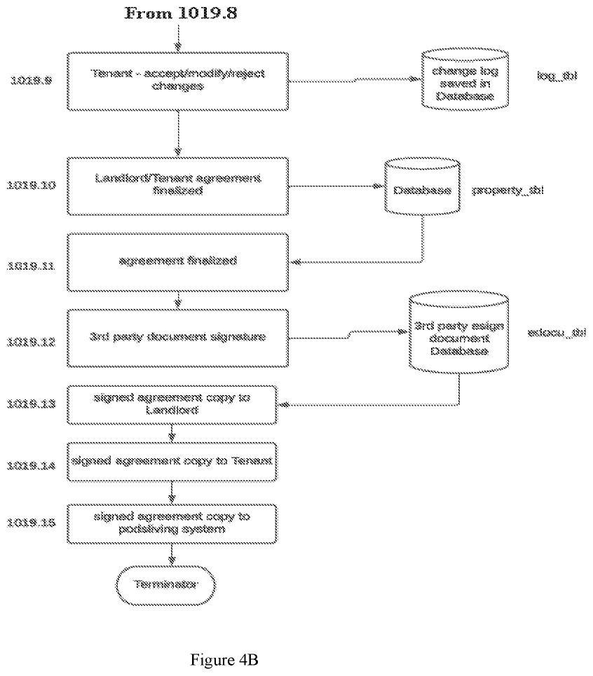

FIGS. 4A and 4B shows a detailed process step for meeting (1019). The process begins with step (1019), when landlord and tenant meeting are finished; landlord review the guarantor of the tenant (1019.1), guarantor includes the documents regarding personal references, professional references, lease documents, system calculated recommendation about tenant. And from the above data system generates the tenant score. Tenant score is stored in user database by system. Landlord review the tenant score and generate the agreement as shown in step (1019.2) and (1019.3) and the said information will be stored in the property database. If tenant does not have a guarantor, system will provide the guarantor service for tenant.

When landlord finalizes the agreement, system (1) store the data in property Database (3.4) and notifies the tenant about the agreement as shown in step (1019.4). After reviewing the agreement if tenant accepts the terms and conditions made by the landlord, system sends the agreement for 3^{rd} party signature and provides the signed copy of agreement to the landlord and tenant. But if tenant want to update the agreement including terms and condition as shown in step (1019.5) then system (1) will notify the landlord regarding updating the terms and conditions by the tenant. Landlord will review the modified terms and condition and can accept or reject or modify the changes as shown in step (1019.7) and (1019.8). System (1) will notify the tenant regarding accepting or rejecting or modifying the terms and conditions by the landlord, if tenant also agreeing with the changes made by the landlord then tenant and landlord will finalize the agreement as illustrated in step (1019.9), (1019.10) and (1019.11). Afterwards system (1) will send the documents for third party signatures (1019.12). System (1) will e-sign the said document via 3^{rd} part e-sign document database and will send a signed agreement copy to the landlord, tenant and system (1) as shown in step (1019.13), (1019.14) and (1019.15).

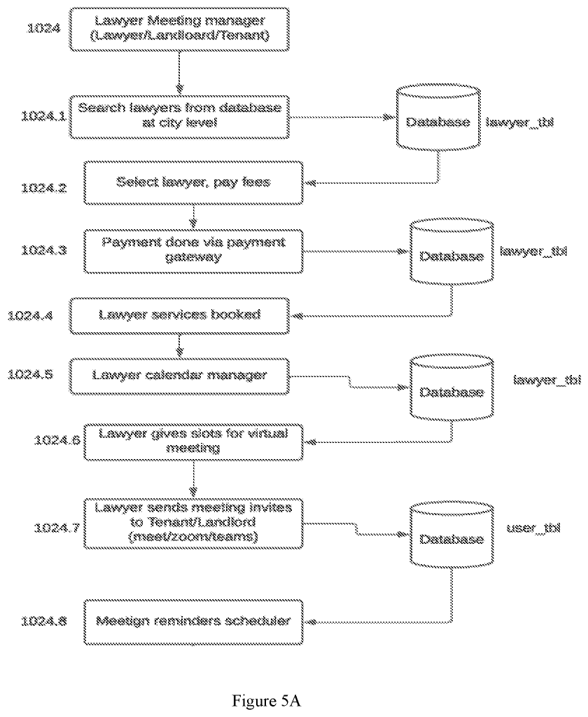

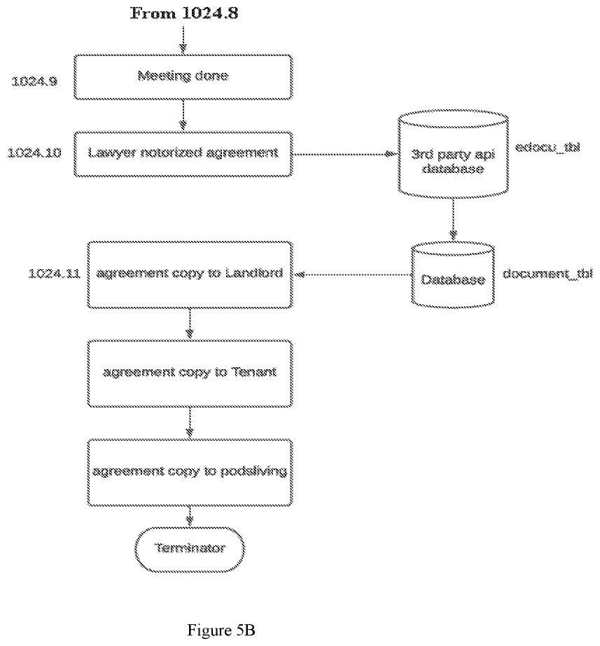

FIGS. 5A and 5B shows a detailed process steps for lawyer meeting manager (1024). System (1) includes lawyer meeting manager (1024) where system (1) will search for a lawyer from database at city level as shown in step (1024.1). After searching, tenant or landlord will pay fees for the lawyer via payment gateway and book the lawyer services as illustrated in step (1024.2), (1024.3) and (1024.4). After booking of lawyer services system (1) go for lawyer calendar manager (1024.5) for checking available slots of lawyer for meeting (1024.6). Lawyer provides available slots for virtual meeting to the tenant and landlord, and sends the meeting invites to the tenant and landlord as shown in step (1024.7). System (1) will send meeting reminders to the tenant and landlord as shown in step (1024.8). After completion of meeting (1024.9), lawyer notarizes the agreement via 3^{rd} party application programming interface database as illustrated in step (1024.10) and as shown in step (1024.11) system (1) will send the copy of agreement to the landlord and tenant.

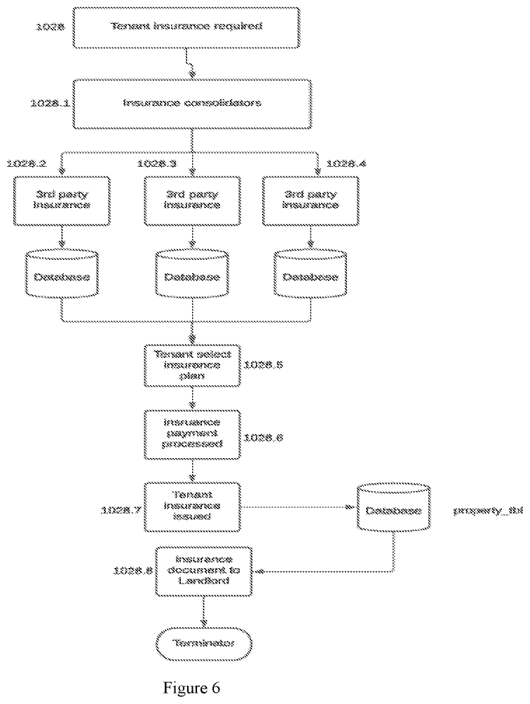

FIG. 6 shows a detailed process step for tenant insurance (1028) where system (1) comprises insurance consolidators (1028.1) and no. of insurance plans in database as illustrated in step (1028.2) (1028.3) and (1028.4). Tenant will select the insurance plan from the system (1) and make the payment for insurance as shown in step (1028.5). After paying the insurance amount (1028.6) tenant insurance will be issued (1028.7) and it will be saved in property Database (3.4) by the system (1) and system (1) send the insurance documents to the landlord.

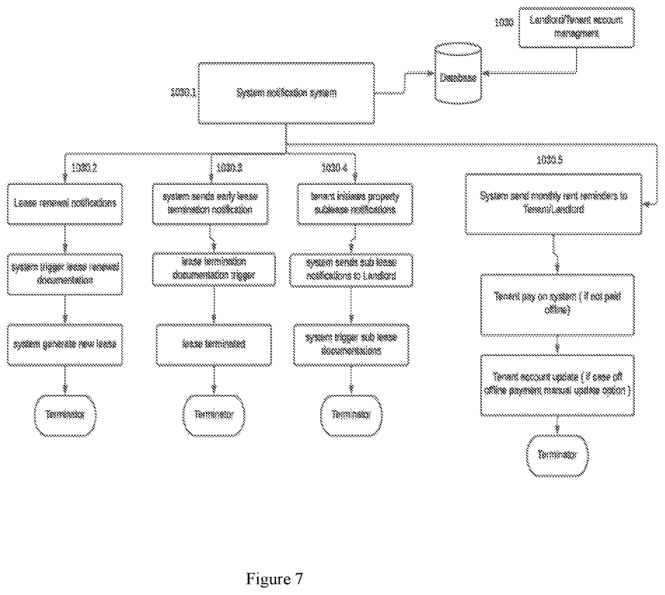

FIG. 7 shows a detailed process steps for landlord/tenant account management (1030) function. Where system (1) comprises system notification system (1030.1) including lease renewal notification (1030.2) and early lease termination notification (1030.3) where system (1) will send notification to the landlord and tenant regarding lease renewal notification and lease termination notification if tenant and landlord wants to renew the lease then system (1) will trigger lease renewal documentation and will generate new lease and if user want to terminate the lease then system (1) will trigger lease termination documentation and lease will be terminated.

System (1) sends notification to the tenant regarding property sublease (1030.4) if tenant initiates property sublease, then system (1) will send sublease notification to then landlord and system (1) will trigger sublease documentation.

Further system (1) also sends monthly rent reminders to the tenant and landlord as shown in step (1030.5). Tenant may pay the rent on system (1). Tenant may also pay the rent to the landlord directly via offline mode. Here if tenant has already paid the rent system (1) will update the tenant profile.

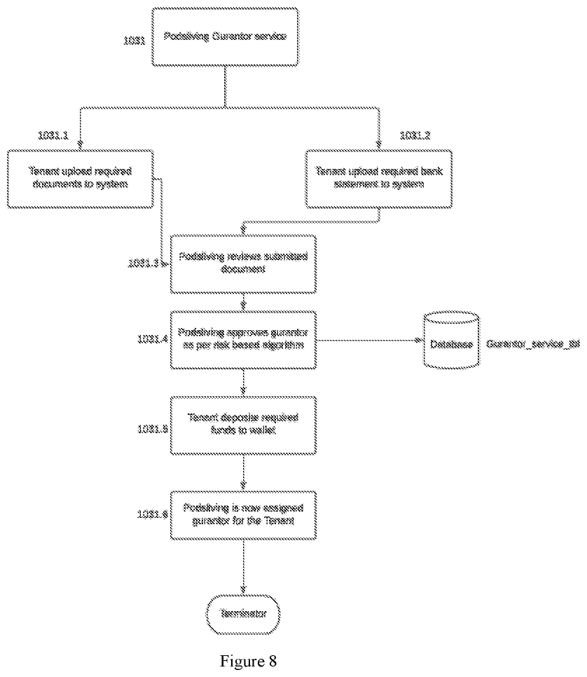

FIG. 8 shows a detailed process step for guarantor service (1031) wherein tenant have to upload required documents and bank statements into the system (1) as illustrated in step (1031.1) and (1031.2). System (1) stores the said data into database. After submitting the documents system (1) reviews the submitted documents and approves guarantor as per risk as shown in step (1031.3) and (1031.4). For guarantor services tenant require to deposit the required funds to the wallet (1031.5). After adding fund to the wallet system (1) is assigned guarantor for the tenant (1031.6).

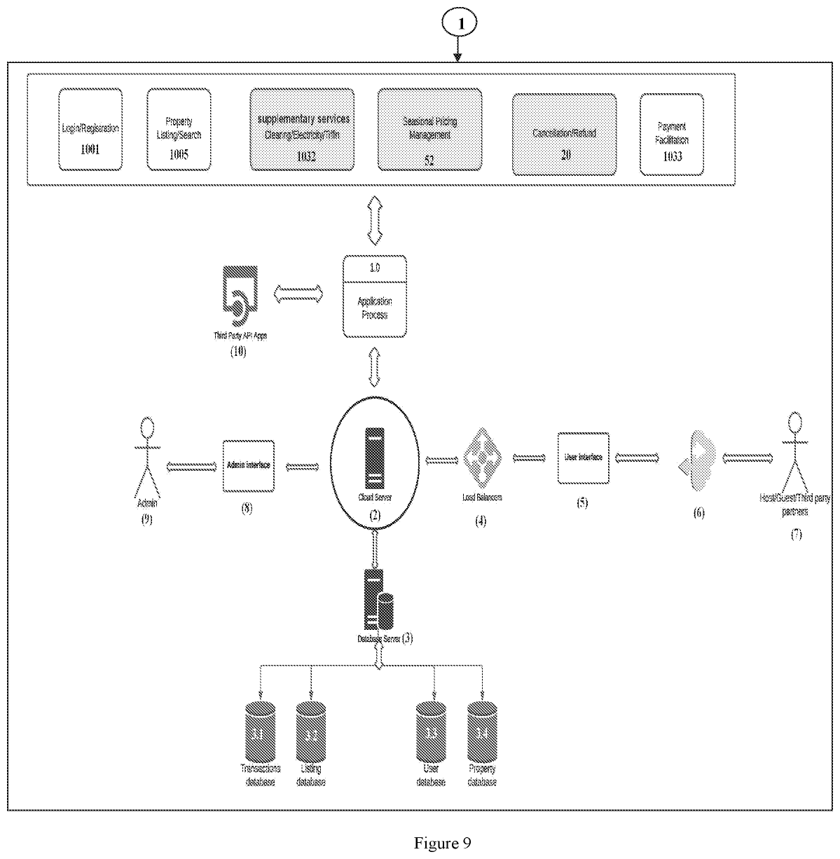

FIG. 9 shows another embodiment of the present invention comprising the plurality of functioning components into the system for short term rental system including login/registration platform (1001), property listing/search for short term renting, seasonal pricing management for managing the seasonal price of property, cancellation and refund services and payment facilitation and the said functioning components are designed with AI (Artificial Intelligence) and machine learning tools. When user registers them, system verifies the details and stores the related data in user database. Once the user register them into the system user can list their property into the system.

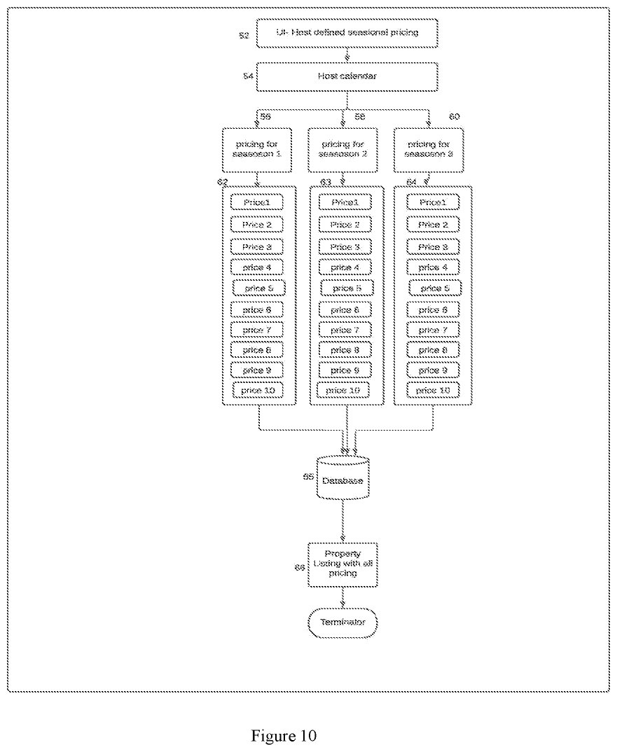

FIG. 10 shows a detailed process step for seasonal pricing. After the registration procedure user may add the property into the system and can define the price for his/her property according to seasons. System will store the said data into database. User may add the prices for the particular season (i.e., summer, winter and rainy) (56, 58, 59) and for particular weeks or day or occasions into a calendar as shown in step (62, 63, and 64). System stores the prices of the property in property database and system list the property with all pricing in property listing platform (66). After the listing of the property guest may select one of the property. System checks the availability of the room into property database for that property. If the room is not available, system will redirect the user to property listing platform again; and if the property is available, host may select that property and pay the rent for the room and book the room.

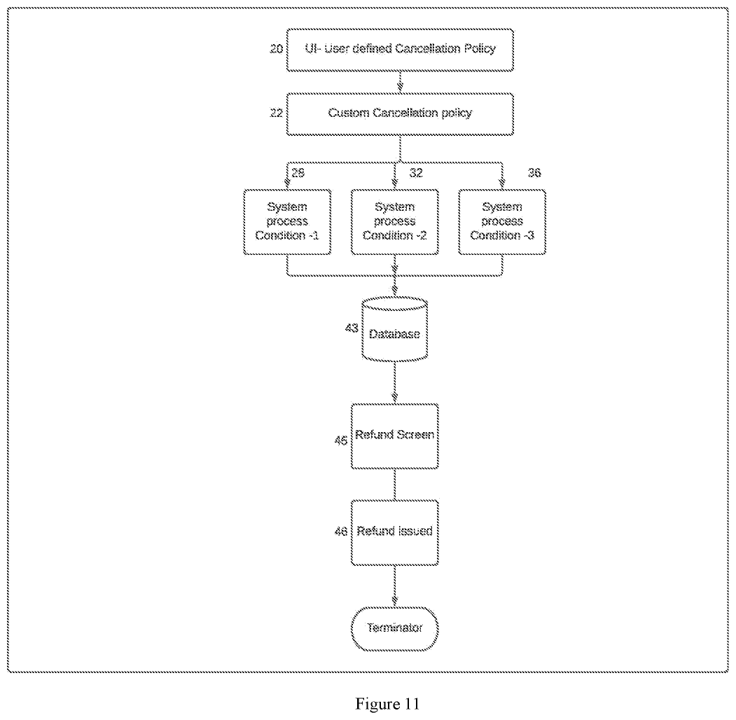

System for short term rental system includes customizable cancellation services for the user where user will get the refund of the money if he/she cancels the booking of the room. As shown in FIG. 11 system comprises user defined cancellation policy (20) where user can custom their cancellation policy (22). User will get at least one conditions by system (28, 32, 36). Once user selects at least one condition from the system, system will store the data into database. Afterwards user is directed to refund screen (45) and his or her refund (46) will be issued.

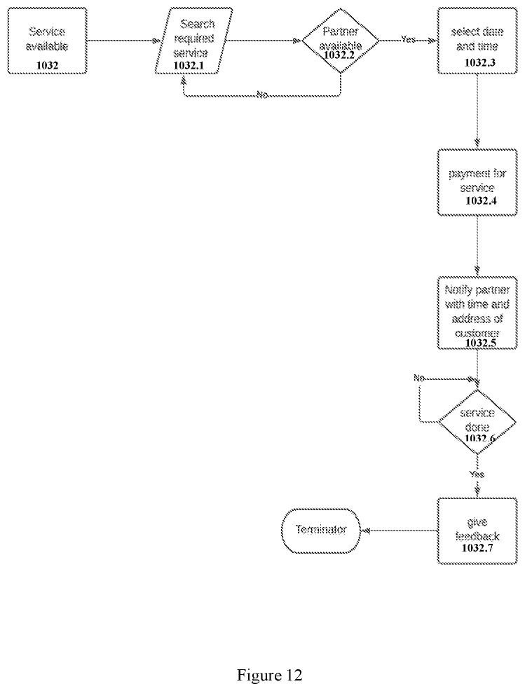

FIG. 12 shows a detailed process steps for supplementary services (1032) wherein user gets the additional services like Tiffin services, plumbing, electricity service etc. when user requires additional service, user will search for the service from the system (1) as shown in step (1032.1) and system (1) will start search for the available partners for perform the selected service into database as shown in step (1032.2). If partner is available (1032.2) for the said service then user will select the time and date for the service and pay the fees for the service as shown in step (1032.3) and (1032.4). System (1) will notify the partner with time and address of customer for service (1032.5). After completion of service user can give feedback for the partner as shown in step (1032.6) and (1032.7).

While various embodiments of the present invention have been described in detail, it is apparent that modifications and adaptations of those embodiments will occur to those skilled in the art. It is expressly understood, however, that such modifications and adaptations are within the scope of the present invention as set forth in the following claims:

### REFERENCE NUMERALS

1—System
2—Cloud server
3—Database server
3.1—Transaction database
3.2—Listing database
3.3—User Database
3.4—Property Database
3.5—Action database
4—Load balancers
5—User Interface
6—Network
7—User
8—Admin Interface
9—Admin
10—Third party application programming interface apps
20—Cancellation policy
22—Custom cancellation policy
28, 32, 36—System process conditions
45—Refund screen
46—Refund issued
52—Seasonal pricing management
54—Host calendar
56, 58, 60—Pricing for different seasons
62,63,64—Prices
1001—Login/registration
1005—Property listing/search
1008—Property Showing
1013—Meeting management
1020—Agreement negotiations
1021—Notarization
1030—Leasing/subleasing
1031—Guarantor services
1026—Insurance
1032—supplementary services
1033—Payment facilitation

We claim:

1. A system for providing versatile solutions to rental platform with artificial intelligence comprises:
a computing device,
a network (6),
a cloud server (2),
a plurality of Database server (3) coupled with the cloud server (2),
a load balancers (4) distributes the information received from the user throughout the cloud server (2),
an user Interface (5) preferably allows the user (7) to establish a connection with the Database server (3),
an admin Interface (8) preferably allows admin (9) to manage the system (1) residing on the cloud server (2),
a third party application programming interface apps (10); and
a plurality of functioning components for long term renting including a login/registration platform, a property listing/search platform (1005), a property showing platform (1008), a meeting management platform (1013), an agreement negotiation platform (1020), a notarization platform (1024), a leasing/sub leasing platform (1030), a guarantor services (1031), an insurance services (1026), an supplementary services platform and payment facilitation platform and a plurality of functioning components for short term renting including seasonal pricing management platform (52), and cancellation and refund services (22).

2. The system (1) for providing versatile solutions to rental platform with artificial intelligence as claimed in claim 1, wherein plurality of Database server (3) includes a transaction database (3.1), a listing database (3.2), an user Database (3.3), a property Database (3.4) and an action database (3.5).

3. The system (1) for providing versatile solutions to rental platform with artificial intelligence as claimed in claim 1 wherein the third party application programming interface apps (10) allows user to access their functionality via application process and use it on system (1).

4. The system (1) for providing versatile solutions to rental platform with artificial intelligence as claimed in claim 1 wherein meeting management platform (1013) includes calendar management, meeting scheduler and reminders schedulers.

5. The system (1) for providing versatile solutions to rental platform with artificial intelligence as claimed in claim 1 wherein the supplementary services (1032) platform includes services like electricity, plumbing, Tiffin services and the like.

6. The system (1) for providing versatile solutions to rental platform with artificial intelligence as claimed in claim 1 wherein the said functional components are designed with AI (Artificial Intelligence) and machine learning tools.

7. A method for providing versatile solutions to rental platform with artificial intelligence for long term comprising:
(a) Registering and logging on login/registration platform into the system (1) by landlord (1001),
(b) Verifying landlord profile (1002) via third party verification application programming interface (1003),
(c) Creating property listing (1005) on property listing platform and defining the terms (1006),
(d) Publishing the property (1007) in UI property listing (1008),
(e) Searching of property by tenant on property searching platform (1009) into the system (1),
(f) Getting results from property Database (3.4),
(g) Short listing the property on property showing platform (1010) into the system (1) by tenant,
(h) Sending meeting request to the landlord (1012) for selected property through meeting management platform (1013),
(i) Checking meeting availability (1015) in landlord meeting calendar (1014) into user Database (3.3) and if dates are available tenant gets meeting slot (1016) and the said slot timing is stored in user Database (3.3),
(j) Scheduling a video meeting (1017) on meeting management platform into the system (1) and storing in database,
(k) Sending reminders and notification to the landlord and tenant regarding meeting (1018),
(l) Finalizing the tenancy agreement on agreement negotiation platform after meeting (1020),
(m) Notarizing the agreement on notarization platform (1021),
(n) Searching for a lawyer (1022) on notarization platform into database by system (1) and paying the fees for lawyer (1023),
(o) Verifying and notarizing the documents via lawyer meeting manager (1024),
(p) Notifying the landlord and tenant when lawyer verify and notarize the documents,
(q) Allocating the property to the tenant (1025) and paying security deposit (1026) and rent (1027) via payment gateway into the system (1) and stores in property Database (3.4),
(r) Providing insurance to the tenant (1028),
(s) Managing tenant and landlord account (1030).

8. The method for providing versatile solutions to rental platform with artificial intelligence as claimed in claim 6 wherein the step (h) shows meeting management component to the tenant wherein tenant can view the available time slot (1013.2) and select the time slot for virtual property showing (1013.4) once getting approval for selected time slot by landlord (1013.5).

9. The method for providing versatile solutions to rental platform with artificial intelligence as claimed in claim 6 wherein the step (l), tenant score is provided through guarantor service to the tenant and landlord.

10. The method for providing versatile solutions to rental platform with artificial intelligence as claimed in claim 6 wherein the step (l), guarantor includes documents regarding personal references, professional references, lease documents, system calculated recommendation about tenant.

11. The method for providing versatile solutions to rental platform with artificial intelligence as claimed in claim 6 wherein the step (o), lawyer provides time slot for virtual meeting (1024.6) and sends meeting invites to the tenant and landlord (1024.7), and after meeting lawyer notarize the documents through 3^{rd} party application programming interface database (1024.10) and sends agreement copy to tenant and landlord (1024.11).

12. The method for providing versatile solutions to rental platform with artificial intelligence as claimed in claim 6 wherein the step (r) system (1) provides plurality of insurance plans to the tenant.

13. The method for providing versatile solutions to rental platform with artificial intelligence as claimed in claim 6 wherein the step (s) system (1) provides notification for lease renewal (1030.2), notification for early lease termination (1030.3), notification for sublease the property (1030.4) and reminders for paying monthly rent (1030.5).

14. A method for providing versatile solutions to rental platform with artificial intelligence for short term comprising:
(a) Registering and logging on login/registration platform into the system (1) by user,
(b) Adding property into property database by host,
(c) Managing seasonal pricing for property by host,
(d) Listing of property into system from property database,
(e) Cancellation and refund services for users.

15. The method for providing versatile solutions to rental platform with artificial intelligence for short term as claimed in claim 14 wherein in step (b) user adds the available dates and prices for rooms in calendar.

16. The method for providing versatile solutions to rental platform with artificial intelligence for short term as claimed in claim 14 wherein step (b) host can add different prices for different seasons.

17. The method for providing versatile solutions to rental platform with artificial intelligence for short term as claimed in claim 14 wherein step (d) guest selects the property from property listing platform.

18. The method for providing versatile solutions to rental platform with artificial intelligence for short term as claimed in claim 14 wherein step (e), guest can customize their cancellation policy on system.
